(19) United States
(12) Patent Application Publication
(10) Pub. No.: US 2026/0116247 A1
(43) Pub. Date: Apr. 30, 2026

(54) CHARGING CONTROL SYSTEM AND CHARGING STATION

(71) Applicants: ZHEJIANG GEELY HOLDING GROUP CO., LTD, Hangzhou, Zhejiang (CN); GEELY AUTOMOBILE RESEARCH INSTITUTE (NINGBO) CO., LTD, Ningbo, Zhejiang (CN)

(72) Inventors: Daiping JIANG, Hangzhou, Zhejiang (CN); Guoyi YANG, Hangzhou, Zhejiang (CN); Shuibao GUO, Hangzhou, Zhejiang (CN); Yue ZHAO, Hangzhou, Zhejiang (CN); Ruifeng ZHANG, Hangzhou, Zhejiang (CN); Xianming YANG, Hangzhou, Zhejiang (CN); Shichao CHEN, Hangzhou, Zhejiang (CN); Cheng WANG, Hangzhou, Zhejiang (CN); Gang LIU, Hangzhou, Zhejiang (CN); Zhen HU, Hangzhou, Zhejiang (CN)

(21) Appl. No.: 18/281,203

(22) PCT Filed: Mar. 31, 2021
(86) PCT No.: PCT/CN2021/084621

§ 371 Date: Jan. 17, 2025

(51) Int. Cl. B60L 53/68; B60L 53/66; B60L 53/67; G06Q 10/20

(52) U.S. Cl. CPC B60L 53/68; B60L 53/665; B60L 53/67; G06Q 10/20

(57) ABSTRACT

A charging control system and a charging station. The charging control system comprises: at least one charging control module at a charging management layer, each charging control module comprising a charging management unit as an electronic control unit; and at least one power control module at a power management layer, each of the power control modules comprising a power management unit as an electronic control unit and a power distributing unit connected to the power management unit; wherein each of the charging management units is configured to be connected to at least one vehicle to be charged, receive a charging request of the vehicle to be charged, and send the charging request to the power management unit connected thereto; and the power management unit is configured to control the power distributing unit to distribute power to the charging management unit according to a scheduling instruction and the received charging request.

### CROSS-REFERENCE TO RELATED APPLICATION

This Application is a national stage application of PCT/CN2021/084621. This application claims priority from PCT Application No. PCT/CN2021/084621, filed Mar. 31, 2021, the content of which is incorporated herein in the entirety by reference.

### TECHNICAL FIELD

The present disclosure relates to the field of charging control technology, in particular to a charging control system and a charging station.

### Background Art

With the development of electric vehicles, the demand of charging piles or stations is increasing. At present, the charging piles or charging stations are mainly constructed as being integrated and separated. By the integrated structure, the control of the power module and the charging control are integrated in a cabinet, and can be uniformly controlled by a controller. By the split structure, the function control is mainly performed in a module cabinet, the charging control, and the service settlement, etc. are performed in a terminal gun cabinet. However, both solutions have to be custom developed, all controllers are coupled to each other and involve strong coupling with the application scenarios and internal electrical components, so that different products have to be developed for different application scenarios, resulting in long development cycles and high costs, which is unfavorable for rapid deployment and operational maintenance of charging posts or stations.

### SUMMARY

In view of the above, provided is a charging control system and a charging station that overcome or at least partially solve the above problems.

It is an object of the present disclosure to provide a charging control system with a hierarchical control architecture and a modular design that can be quickly deployed in combination according to application scenarios, saving development time and costs.

It is a further object of the present disclosure to enhance the usability and robustness of the charging control system.

It is another object of the present disclosure to provide a charging station including the charging control system.

In particular, according to an aspect of an embodiment of the disclosure, provided is a charging control system including:
at least one charging control module at a charging management layer, each charging control module including a charging management unit as an electronic control unit; and
at least one power control module at a power management layer, each of the power control modules including a power management unit as an electronic control unit and a power distributing unit connected to the power management unit;
wherein the power management layer is an upper layer of the charging management layer, and the power management unit in each of the power control modules is connected to the charging management unit in at least one of the charging control modules;
each of the charging management units is configured to be connected to at least one vehicle to be charged, receive a charging request of the vehicle to be charged, and send the charging request to the power management unit connected thereto; and
the power management unit is configured to control the power distributing unit to distribute power to the charging management unit according to a scheduling instruction and the received charging request, and monitor the charging management unit to charge the vehicle to be charged with the distributed power to complete charging power control.

Alternatively, each of the power management units is connected to a cloud, configured to receive the scheduling instruction from the cloud, collect state information about the charging control system and upload same to the cloud for service settlement, wherein the state information about the charging control system includes working state information about each unit and charging control and service information.

Alternatively, the charging control system further includes:
a service control module at a site monitoring layer, including a site monitoring unit as an electronic control unit;
the site monitoring layer is an upper layer of the power management layer; and
the site monitoring unit is respectively connected to the power management unit in each of the power control modules, configured to issue the scheduling instruction to the power management unit, and collect state information about the charging control system, wherein the state information about the charging control system includes working state information about each unit and charging control and service information.

Alternatively, the site monitoring unit is connected to a cloud, configured to receive the scheduling instruction from the cloud to perform station management when connected to the cloud normally, and upload collected state information about the charging control system to the cloud to perform service settlement.

Alternatively, the site monitoring unit is further configured to perform site management autonomously when the connection with the cloud is lost, and store the collected state information about the charging control system locally until the state information about the charging control system is uploaded after the connection with the cloud is reestablished.

Alternatively, the power management unit is further configured to autonomously perform the charging power control when the connection with the site monitoring unit is lost, and record the charging control and service information, and report the charging control and service information to the site monitoring unit until the connection with the site monitoring unit is reestablished.

Alternatively, the charging control system further includes:
at least one energy storage control module at the power management layer, each energy storage control module including an energy management unit as an electronic control unit and an energy storage device connected to the energy management unit;
in the case where the charging control system does not include the site monitoring layer, the energy management units are respectively connected to each of the power management units and configured to control the energy storage device to perform energy storage and discharge in cooperation with each of the power management units; and
in the case where the charging control system includes the site monitoring layer, the energy management unit is respectively connected to each of the power management units and the site monitoring unit, and is configured to control the energy storage device to perform energy storage and discharge under deployment control of the site monitoring unit and/or in cooperation with each of the power management units.

Alternatively, each of the power control modules further includes a plurality of power modules; and
the power distributing unit is configured to execute switching logic of the power module under control of the power management unit to distribute power to the charging management unit.

Alternatively, each of the electronic control units operates in at least one of the following modes:
an upper layer deployment control mode configured to control the operation according to the distribution of the electronic control unit of the upper layer;
an autonomous mode configured to operate autonomously;
a same-layer cooperation mode configured to cooperate with other electronic control units of the same layer; and
the priorities of the upper layer deployment control mode, the same layer cooperation mode and the autonomous mode decrease in sequence.

Alternatively, each of the power management units is further configured to automatically disengage the charging control system and stop control of the power distributing unit and the charging management unit connected thereto after a failure thereof.

Alternatively, each of the charging management units is further configured to automatically disengage the control of the power management unit connected thereto and stop charging after a failure thereof.

Alternatively, each of the energy management units is further configured to automatically disengage the charging control system and cease control of the energy storage device connected thereto after a failure thereof.

Alternatively, the charging control system is installed at a charging station including a camera device, a ground lock system, and an access control system;
the site monitoring unit is respectively connected to the camera device, the ground lock system, and the access control system, and is further configured to collect an image of the camera device for environmental monitoring, and to control the ground lock system and the access control system.

Alternatively, the power management unit is further configured to perform voltage insulation monitoring in response to the charging request.

Alternatively, the charging management unit is further configured to provide at least one of the following functions:
a function of interacting with the vehicle to be charged, a function of human-computer interaction with a user, and a liquid cooling control function.

According to another aspect of embodiments of the present disclosure, also provided is a charging station including a charging control system as described in any of the above.

According to the charging control system provided by an embodiment of the present disclosure, a hierarchical control architecture and a modular design are used, wherein a network architecture of the charging control system includes a charging management layer and a power management layer, and may optionally further include a site monitoring layer; the module architecture of the charging control system includes a charging control module and a power control module, and optionally a service control module and an energy storage control module. In this way, complete decoupling of the charging control system in terms of function, electrical arrangement, and physical space is achieved, so that it can be quickly deployed in combination according to application scenarios, saving development time and cost.

Further, the embodiments of the present disclosure provide a charging control system in which each module uses a combination of single master control and multi-master automatic cooperation, can work cooperatively with each other or independently, and has high system availability. Further, any module failure can automatically leave the control system without affecting the operation of other modules, and the system has high robustness and easy maintenance.

The above description is merely an overview of the technical aspects of the present disclosure, which can be carried out in accordance with the contents of the description in order to make the technical aspects of the present disclosure more clearly understood, and in order to make the above and other objects, features, and advantages of the present disclosure more apparent, embodiments of the present disclosure will be described below.

The above and other objects, advantages and features of the present disclosure will become more apparent to a person skilled in the art from the following detailed description of embodiments of the disclosure when taken in conjunction with the accompanying drawings.

### BRIEF DESCRIPTION OF THE DRAWINGS

Specific embodiments of the disclosure will be described in detail hereinafter, by way of example and not limitation, with reference to the accompanying drawings. Wherever possible, the same reference numbers will be used throughout the drawings to refer to the same or like parts or portions. A person skilled in the art would appreciate that the figures are not necessarily drawn to scale. In the drawings:

FIG. 1 is a schematic block diagram of a charging control system according to an embodiment of the disclosure;

FIG. 2 is a schematic block diagram of a charging control system according to another embodiment of the disclosure;

FIG. 3 is a hierarchical architecture diagram of a charging control system according to an embodiment of the disclosure;

FIG. 4 is a schematic diagram showing a constitution of a charging control system according to an embodiment of the present disclosure.

### DETAILED DESCRIPTION OF THE DISCLOSURE

Exemplary embodiments of the present disclosure will be described in more detail below with reference to the accompanying drawings. While the drawings show exemplary embodiments of the present disclosure, it should be understood that the present disclosure may be embodied in various forms and should not be construed as limited to the embodiments set forth herein. Rather, these embodiments are provided so that this disclosure will be thorough and complete, and will fully convey the scope of the disclosure to a person skilled in the art.

To address or at least partially address the above-described problems, embodiments of the present disclosure provide a charging control system.

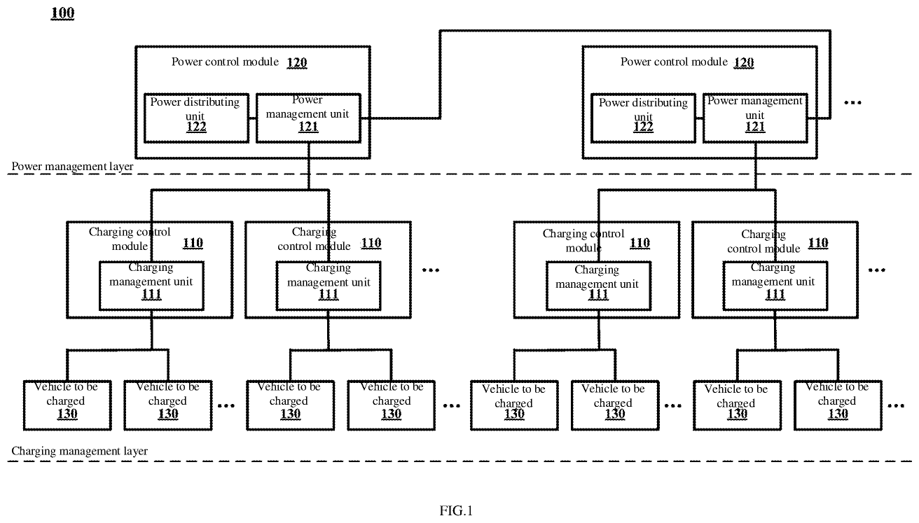

FIG. 1 shows a schematic block diagram of a charging control system 100 according to an embodiment of the present disclosure. Referring to FIG. 1, the charging control system 100 employs a hierarchical control architecture and may generally include at least one charging control module 110 and at least one power control module 120. The hierarchical control architecture of the charging control system 100 may include at least one charging management layer and a power management layer, the power management layer being an upper layer of the charging management layer. The at least one charging control module 110 is in a charging management layer, and each charging control module 110 includes a Charging Management Unit (CMU) 111 as an Electronic Control Unit (ECU). The at least one power control module 120 is in a power management layer, and each power control module 120 includes a Power Management Unit (PMU) 121 as an electronic control unit and a Power Distributing Unit (PDU) 122 connected to the power management unit 121. The power management unit 121 in each power control module 120 is connected to the charging management unit 111 in at least one charging control module 110. Each charging management unit 111 may be configured to connect with at least one vehicle to be charged 130, receive a charging request of the vehicle to be charged 130, and send the charging request to the power management unit 121 connected thereto. The power management unit 121 controls the power distributing unit 122 connected to the power management unit 121 to distribute power to the charging management unit 111 according to the scheduling instruction and the received charging request, and monitors the charging management unit 111 to charge the vehicle to be charged 130 using the distributed power to complete the charging power control. It should be noted that the number of components shown in FIG. 1 is merely illustrative and does not limit the disclosure.

According to the charging control system 100 provided by an embodiment of the present disclosure, a hierarchical control architecture and a modular design are used, wherein the network architecture of the charging control system 100 includes a charging management layer and a power management layer, and the module architecture of the charging control system 100 includes a charging control module 110 and a power control module 120. In this way, the modules can be decoupled, achieving complete decoupling of the charging control system 100 in terms of function, electrical arrangement, and physical space, so that it can be quickly deployed in combination according to application scenarios, saving development time and cost.

According to a further embodiment, each power management unit 121 may interact directly with a cloud connection (e.g., a wireless connection or a wired Ethernet interface). The power management unit 121 receives the scheduling instruction from the cloud, collects state information about the charging control system 100 and uploads same to the cloud for service settlement. According to the embodiment, the state information of the charging control system 100 includes operation state information of each unit (specifically, such as the power management unit 121, the power distributing unit 122, the charging management unit 111, etc.) and charging control and service information (such as charging time, amount of charge consumed by charging, charging user information, etc.).

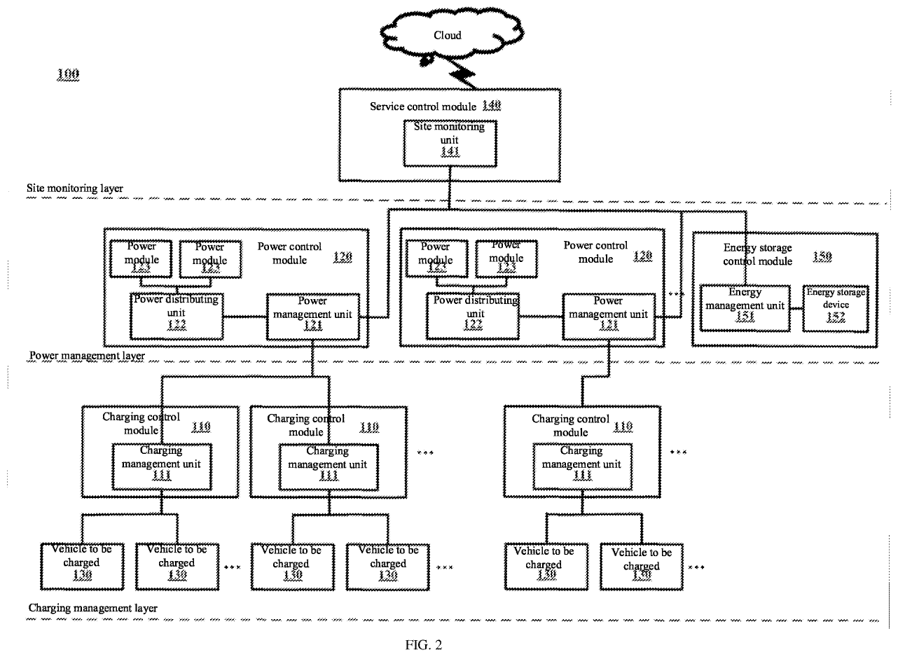

FIG. 2 shows a schematic block diagram of a charging control system 100 according to another embodiment of the present disclosure. It should be noted that the number of components shown in FIG. 2 is merely illustrative and does not limit the disclosure.

According to an embodiment of the present disclosure, illustrated with reference to FIG. 2, the network architecture of the charging control system 100 may also include a site monitoring layer, which is an upper layer of the power management layer. The charging control system 100 may also include a service control module 140. The service control module 140 is located at a site monitoring layer, and includes a Station Monitor Unit (SMU) 141 as an electronic control unit. The site monitoring unit 141 is respectively connected to the power management unit 121 in each power control module 120, and is configured to issue a scheduling instruction to the power management unit 121 and collect state information about the charging control system 100. According to the embodiment, the state information of the charging control system 100 includes operation state information of each unit (specifically, the site monitoring unit 141, the power management unit 121, the power distributing unit 122, the charging management unit 111, etc.) and charging control and service information.

According to a further embodiment, the site monitoring unit 141 may be connected to a cloud (e.g., a wireless connection or a wired Ethernet interface). The site monitoring unit 141 receives the scheduling instruction from the cloud for site management when normally connected to the cloud, and uploads the collected state information of the charging control system 100 to the cloud for service settlement.

According to some embodiments, when the site monitoring unit 141 loses connection with the cloud, the site monitoring unit 141 may autonomously perform station management (at this time, a scheduling instruction is autonomously generated by the site monitoring unit 141), and locally store the collected state information about the charging control system 100 until the state information about the charging control system 100 is uploaded after the connection with the cloud is reestablished.

According to other embodiments, when the power management unit 121 loses connection with the site monitoring unit 141, the power management unit 121 may also autonomously perform charging power control to complete vehicle charging, record charging control and service information, and report the charging control and service information to the site monitoring unit 141 until a connection is reestablished with the site monitoring unit 141.

The above-described embodiments can ensure that the charging control system 100 is still functioning properly in the event of a local connection failure and avoid data loss.

According to an alternative embodiment, as shown with continued reference to FIG. 2, the charging control system 100 may also include at least one energy storage control module 150 at the power management level. Each energy storage control module 150 includes an Energy Management Unit (EMU) 151 as an electronic control unit and an energy storage device 152 (e.g. a battery, etc.) connected to the energy management unit 151. In the case where the charging control system 100 does not include a site monitoring layer, the energy management units 151 may be respectively connected to each of the power management units 121 and configured to cooperate with each of the power management units 121 to control the energy storage devices 152 to store and discharge energy to function as a charging sink and energy balancer for the entire charging pile/station. In the case where the charging control system 100 includes a site monitoring layer, the energy management unit 151 may be connected to each of the power management units 121 and the site monitoring unit 141, respectively, and configured to control the energy storage device 152 to store and discharge energy under deployment control of the site monitoring unit 141 and/or in cooperation with each of the power management units 121 to function as a charging sink and energy balancer for the entire charging pile/station. Further, when the charging control system 100 includes the energy storage control module 150, the operation state information of each unit included in the state information of the charging control system 100 mentioned above also includes the operation state information of the energy management unit 151.

According to an alternative embodiment, with continued reference to FIG. 2, each power control module 120 further includes a plurality of power modules 123. The power distributing unit 122 executes switching logic of the power module 123 under the control of the power management unit 121 to distribute power to the charging management unit 111.

According to a preferred embodiment of the present disclosure, each of the electronic control units of the charging control system 100 (specifically, the site monitoring unit 141, the power management unit 121, the energy management unit 151, and the charging management unit 111) may operate in at least one of an upper-level deployment control mode, an autonomous mode, and a same-layer cooperation mode. The upper-layer deployment control mode refers to operating according to the deployment control of the electronic control unit of the upper layer, for example, the power management unit 121 or the energy management unit 151 in the power management layer operates under the deployment control of the site monitoring unit 141 in the site monitoring layer, or the charging management unit 111 in the charging management layer operates under the deployment control of the power management unit 121. The autonomous mode means that the electronic control unit operates autonomously, for example, the site monitoring unit 141 performs site management autonomously when the connection with the cloud is lost. The same-layer cooperation mode means that the electronic control unit operates in cooperation with other electronic control units of the same layer, for example, the energy management unit 151 may operate in cooperation with the power management unit 121, or a power management unit 121 may operate in cooperation with the energy management unit 151 or other power management units 121. Under the normal operation condition of the charging control system 100, the above-mentioned three operation modes coexist, and the priorities of the upper layer deployment control mode, the same-layer cooperation mode and the autonomous mode decrease in sequence, i.e., the priority order is: the upper layer distribution control mode>the same-layer cooperation mode>the autonomous mode.

According to the embodiment, each module of the charging control system 100 uses a combination of a single master control (i.e., deployment control via a single site monitoring unit 141) and multi-master automatic cooperation (i.e., coordinated operation of multiple electronic control units at the same layer), and can work cooperatively with each other or independently, thereby enhancing system availability.

According to some embodiments, any of the power management units 121 may automatically disengage from the charging control system 100 and stop control of the power distributing unit 122 and the charging management unit 111 connected thereto after a failure in itself. That is, the power control module 120 in which the failed power management unit 121 is located automatically departs from the control system 100.

According to some embodiments, any one of the charging management units 111 may automatically disengage the control of its connected power management unit 121 and stop charging after a failure in itself. That is, the charging control module 110 where the failed charging management unit 111 is located automatically comes out of the control system 100.

According to some embodiments, any of the energy management units 151 may automatically disengage the charging control system 100 and cease control of the energy storage device 152 connected thereto after a failure in itself. That is, the energy storage control module 150 in which the failed energy management unit 151 is located automatically disengages from the control system 100.

With this design, any module failure can automatically leave the control system 100 without affecting the operation of other modules, enhancing system robustness, and facilitating maintenance. In addition, a repaired failed module or an added new module may be automatically entered into the control system 100 for operation “plug and play”.

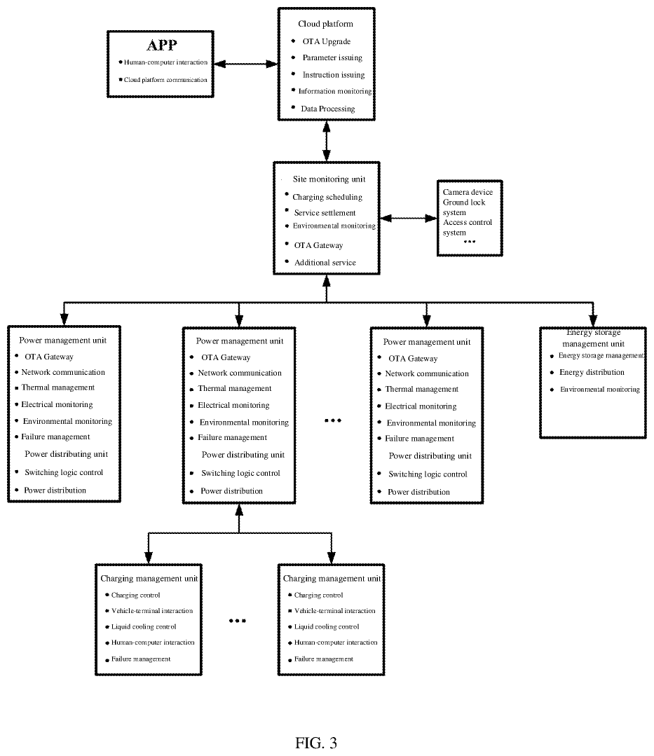

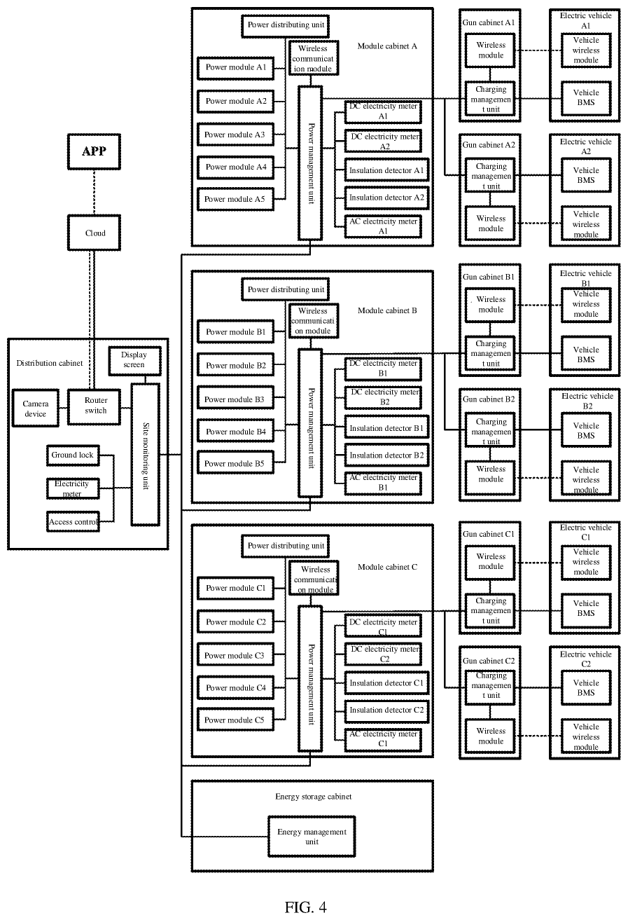

FIG. 3 shows a hierarchical architecture diagram of the charging control system 100 according to an embodiment of the present disclosure, and FIG. 4 shows a schematic diagram of the constituent structures of the charging control system 100 according to an embodiment of the present disclosure. The charging control system 100 according to an embodiment of the present disclosure will be described in more detail with reference to FIGS. 3 and 4.

As shown in FIG. 3, the charging control system 100 of the embodiment is mainly divided into three layers, i.e., a site monitoring layer, a power management layer, and a charging management layer. The functions of the site monitoring layer are realized by the site monitoring unit 141, mainly performing the management of the whole site (e.g. charging scheduling of the site, service settlement, environment monitoring, etc.). The site monitoring unit 141 communicates with a cloud platform (i.e., a cloud) via an Over-the-Air (OTA) gateway. The cloud platform can realize OTA upgrading, parameter issuing, instruction issuing, information monitoring, data processing and other functions. The cloud platform can further communicate with the client APP to achieve human-computer interaction.

The site monitoring unit 141 may also perform other additional services. For example, the charging control system 100 may be installed at a charging station, which may include a camera device, a ground lock system, and an access control system. The site monitoring unit 141 may be connected to the camera device, the ground lock system, and the access control system, respectively, and collect images of the camera device for environmental monitoring, and control the ground lock system and the access control system.

The power management layer consists of a plurality of power management units 121 and power distributing units 122 and energy management units 151. The power management unit 121 can communicate with the site monitoring unit 141 through the OTA gateway, mainly realizing the functions of power management, thermal management, electrical monitoring, and environmental monitoring. Specifically, in the electrical monitoring, the power management unit 121 may perform voltage insulation monitoring in response to the charging request of the charging management unit 111. In addition, the power management unit 121 may also perform fault management in the event of a fault in itself to achieve automatic detachment from control system 100 following the fault. The power distributing unit 122 mainly implements the functions of switching logic control of power, power distribution, etc. The energy management unit 151 mainly implements functions such as energy storage management, energy distribution and environmental monitoring.

The charging management layer is composed of a plurality of charging management units 111, and mainly realizes functions such as communication with the vehicle to be charged 130 (i.e., vehicle-side interaction), charging control, liquid cooling gun cooling system control (i.e., liquid cooling control) and human-computer interaction. The charging management unit 111 may also perform failure management when it itself fails to automatically disengage the control system 100 after the failure.

The ECU of the same layer can accept the deployment control of the ECU of the upper layer, can also operate autonomously, and can also operate in cooperation with other ECU of the same layer. Under normal operation, the above three operation modes coexist, and the priority order is: upper-level ECU deployment control>co-operation of same-level ECU>autonomous operation. When an ECU loses the distribution control of the upper ECU, it will automatically turn to cooperative operation or autonomous operation. The power management unit 121 of the power management layer is also responsible for controlling the power distributing unit 122 to achieve the full functionality of power management. The energy management unit 151 controls the battery energy storage cabinet, and performs energy storage and discharge under the deployment control of the upper-layer site monitoring unit 141 and in cooperation with the power management unit 121 of the same layer to provide a charging pile/station with a charging treasure and an energy balancer function.

FIG. 4 shows the constitution of the charging control system 100 of the embodiment in more detail. The service control module 140 is provided in a power distribution cabinet (or a low voltage cabinet), each power control module 120 is provided in a corresponding module cabinet, the energy control module is provided in an energy storage cabinet, and each charging control module 110 is provided in a corresponding gun cabinet.

The site monitoring unit (SMU) is responsible for managing the whole station, communicating with the cloud, uploading state information about the charging control system 100 and receiving a cloud scheduling instruction; the power management unit PMU in the module cabinet and the energy management unit EMU in the energy storage cabinet are connected downward via a bus such as Ethernet or Controller Area Network (CAN), and information about the working state of each PMU and EMU is collected and scheduling control is performed (such as energy charging and discharging control of the energy storage cabinet, power distribution control of each module cabinet, etc.).

The PMU in the module cabinet is the core component of the charging control system 100, and is respectively connected to the site monitoring unit SMU and other PMUs/EMUs via a CAN network or an Ethernet network, and reports working state information and receives scheduling instructions, or performs cooperative control with other PMUs/EMUs. PMU has two paths of CAN network downwards, one path is connected to the power module in the module cabinet and the power distributing unit PDU to realize power distribution scheduling and module switching control, and the other path is connected to the charging management unit CMU of the gun cabinet to realize interactive control of the charging process. PMU also collects information such as voltage insulation via buses such as RS485 (e.g., collecting information detector) to provide necessary information for power control, charging interaction and service settlement. The CMU in the gun cabinet interacts with the vehicle to control charging, and interacts with the PMU to complete the charging process, while providing the necessary human-computer interaction (e.g., information display), gun cabinet monitoring, heat management of liquid-cooled gun, etc.

As shown in FIG. 4, there may be multiple gun cabinets and module cabinets. A charging station may be provided with one or more energy storage cabinets and one or more module cabinets. A module cabinet can be connected to one or more gun cabinets, and a gun cabinet can be connected to one or more vehicles (in particular electric vehicles) to be charged. Gun cabinets, module cabinets and energy storage cabinets may be added or deleted as required by the charging station. The charging management unit (CMU) of each gun cabinet is controlled by the PMU of the module chest and requests the PMU to output the required power for charging after interacting with the vehicle. PMU monitors the operation of CMU, completes insulation monitoring, power distribution, etc. in response to the request of CMU, and finally achieves the charging function. At the same time, the PMU also controls the PDU and each power module according to the request of each CMU, the scheduling instruction of the SMU, and the states of other PMU and the EMU to distribute the power of each power module to each gun cabinet, and then transmits energy to the Battery Management System (BMS) of the vehicle via the gun cabinet.

If the SMU loses communication with the cloud, the SMU directly performs site management and completes storage of all charging control and business information, and uploads relevant charging control and business information after establishing a connection with the cloud and completes service settlement. Similarly, if the PMU is disconnected from the SMU, each PMU can perform charging power control to complete the charge, record the charge data, and report the recorded charge data after the connection with the SMU is successful. If the PMU of one module cabinet or the EMU of the energy storage cabinet fails, it automatically leaves the system and stops the power control of this module cabinet, without affecting the operation of other cabinets. If the CMU of a gun cabinet fails, the gun cabinet automatically disengages from the control system 100 and stops charging without affecting other gun cabinet charges.

According to the embodiment, by means of hierarchical design and modular design, various modules can be operated in combination or independently, there are multiple independent vehicle charging connections from the lower layer to the upper layer, multiple independent gun cabinets, multiple independent module cabinets, and any module addition, deletion and damage at the same level will not affect the operation of other modules, and can be rapidly added and subtracted for different scenarios, and can be freely combined to achieve rapid deployment, which greatly enhances the usability and robustness of the system.

Based on the same technical concept, embodiments of the present disclosure also provide a charging station including the charging control system 100 of any one or a combination of the foregoing embodiments.

According to the charging control system provided by an embodiment of the present disclosure, a hierarchical control architecture and a modular design are used, wherein a network architecture of the charging control system includes a charging management layer and a power management layer, and may optionally further include a site monitoring layer; the module architecture of the charging control system includes a charging control module and a power control module, and optionally a service control module and an energy storage control module. In this way, the complete decoupling of the charging control system in function, electrical arrangement and physical space is achieved, so that it can be quickly combined and deployed according to the application scenarios, saving development time and cost.

Further, the embodiments of the present disclosure provide a charging control system in which each module uses a combination of single master control and multi-master automatic cooperation, can work cooperatively with each other or independently, and has high system availability. Further, any module failure can automatically leave the control system without affecting the operation of other modules, and the system has high robustness and easy maintenance.

Thus, a person skilled in the art will appreciate that while exemplary embodiments of the present disclosure have been shown and described in detail herein, many other variations and modifications may be made directly in accordance with the present disclosure without departing from the spirit and scope of the disclosure. Accordingly, the scope of the present disclosure should be understood and interpreted to cover all such other variations or modifications.

1. A charging control system, comprising:
at least one charging control module at a charging management layer, each charging control module comprising a charging management unit as an electronic control unit; and
at least one power control module at a power management layer, each of the power control modules comprising a power management unit as an electronic control unit and a power distributing unit connected to the power management unit;
wherein the power management layer is an upper layer of the charging management layer, and the power management unit in each of the power control modules is connected to the charging management unit in at least one of the charging control modules;
each of the charging management units is configured to be connected to at least one vehicle to be charged, receive a charging request of the vehicle to be charged, and send the charging request to the power management unit connected thereto; and
the power management unit is configured to control the power distributing unit to distribute power to the charging management unit according to a scheduling instruction and the received charging request, and monitor the charging management unit to charge the vehicle to be charged with the distributed power to complete charging power control.

2. The charging control system according to claim 1, wherein each of the power management units is connected to a cloud, configured to receive the scheduling instruction from the cloud, collect state information about the charging control system and upload same to the cloud for service settlement, wherein the state information about the charging control system comprises working state information about each unit and charging control and service information.

3. The charging control system according to claim 1, further comprising:
a service control module at a site monitoring layer, comprising a site monitoring unit as an electronic control unit;
the site monitoring layer is an upper layer of the power management layer; and
the site monitoring unit is respectively connected to the power management unit in each of the power control modules, configured to issue the scheduling instruction to the power management unit, and collect state information about the charging control system, wherein the state information about the charging control system comprises working state information about each unit and charging control and service information.

4. The charging control system according to claim 3, wherein the site monitoring unit is connected to a cloud, configured to receive the scheduling instruction from the cloud to perform station management when connected to the cloud normally, and upload collected state information about the charging control system to the cloud to perform service settlement.

5. The charging control system according to claim 4, wherein the site monitoring unit is further configured to perform site management autonomously when the connection with the cloud is lost, and store the collected state information about the charging control system locally until the state information about the charging control system is uploaded after the connection with the cloud is reestablished.

6. The charging control system according to claim 4, wherein the power management unit is further configured to autonomously perform the charging power control when the connection with the site monitoring unit is lost, and record the charging control and service information, and report the charging control and service information to the site monitoring unit until the connection with the site monitoring unit is reestablished.

7. The charging control system according to claim 1, further comprising:
at least one energy storage control module at the power management layer, each energy storage control module comprising an energy management unit as an electronic control unit and an energy storage device connected to the energy management unit;
in the case where the charging control system does not comprise the site monitoring layer, the energy management units are respectively connected to each of the power management units and configured to control the energy storage device to perform energy storage and discharge in cooperation with each of the power management units; and
in the case where the charging control system comprises the site monitoring layer, the energy management unit is respectively connected to each of the power management units and the site monitoring unit, and is configured to control the energy storage device to perform energy storage and discharge under deployment control of the site monitoring unit and/or in cooperation with each of the power management units.

8. The charging control system according to claim 1, wherein each of the power control modules further comprises a plurality of power modules; and
the power distributing unit is configured to execute switching logic of the power module under control of the power management unit to distribute power to the charging management unit.

9. The charging control system according to claim 1, wherein each of the electronic control units operates in at least one of the following modes:
an upper layer deployment control mode configured to control the operation according to the distribution of the electronic control unit of the upper layer;
an autonomous mode configured to operate autonomously;
a same-layer cooperation mode configured to cooperate with other electronic control units of the same layer; and
the priorities of the upper layer deployment control mode, the same layer cooperation mode and the autonomous mode decrease in sequence.

10. The charging control system according to claim 1, wherein each of the power management units is further configured to automatically disengage the charging control system and stop control of the power distributing unit and the charging management unit connected thereto after a failure thereof.

11. The charging control system according to claim 1, wherein each of the charging management units is further configured to automatically disengage the control of the power management unit connected thereto and stop charging after a failure thereof.

12. The charging control system according to claim 7, wherein each of the energy management units is further configured to automatically disengage the charging control system and cease control of the energy storage device connected thereto after a failure thereof.

13. The charging control system according to claim 3, wherein the charging control system is installed at a charging station comprising a camera device, a ground lock system, and an access control system;
the site monitoring unit is respectively connected to the camera device, the ground lock system, and the access control system, and is further configured to collect an image of the camera device for environmental monitoring, and to control the ground lock system and the access control system.

14. The charging control system according to claim 1, wherein the power management unit is further configured to perform voltage insulation monitoring in response to the charging request.

15. The charging control system according to claim 1, wherein the charging management unit is further configured to provide at least one of the following functions:
a function of interacting with the vehicle to be charged, a function of human-computer interaction with a user, and a liquid cooling control function.

16. A charging station, comprising the charging control system according to any according to claim 1.

17. The charging control system according to claim 2, further comprising:
at least one energy storage control module at the power management layer, each energy storage control module comprising an energy management unit as an electronic control unit and an energy storage device connected to the energy management unit;
in the case where the charging control system does not comprise the site monitoring layer, the energy management units are respectively connected to each of the power management units and configured to control the energy storage device to perform energy storage and discharge in cooperation with each of the power management units; and
in the case where the charging control system comprises the site monitoring layer, the energy management unit is respectively connected to each of the power management units and the site monitoring unit, and is configured to control the energy storage device to perform energy storage and discharge under deployment control of the site monitoring unit and/or in cooperation with each of the power management units.

18. The charging control system according to claim 3, further comprising:
at least one energy storage control module at the power management layer, each energy storage control module comprising an energy management unit as an electronic control unit and an energy storage device connected to the energy management unit;
in the case where the charging control system does not comprise the site monitoring layer, the energy management units are respectively connected to each of the power management units and configured to control the energy storage device to perform energy storage and discharge in cooperation with each of the power management units; and
in the case where the charging control system comprises the site monitoring layer, the energy management unit is respectively connected to each of the power management units and the site monitoring unit, and is configured to control the energy storage device to perform energy storage and discharge under deployment control of the site monitoring unit and/or in cooperation with each of the power management units.

19. The charging control system according to claim 2, wherein each of the power control modules further comprises a plurality of power modules; and
the power distributing unit is configured to execute switching logic of the power module under control of the power management unit to distribute power to the charging management unit.

20. The charging control system according to claim 3, wherein each of the power control modules further comprises a plurality of power modules; and
the power distributing unit is configured to execute switching logic of the power module under control of the power management unit to distribute power to the charging management unit.
